(19) United States
(12) Patent Application Publication
(10) Pub. No.: US 2021/0271183 A1
(43) Pub. Date: Sep. 2, 2021

(54) IMAGING SYSTEM, CURRENT CONTROL PROGRAM FOR IMAGING SYSTEM

(71) Applicant: Hewlett-Packard Development Company, L.P., Spring, TX (US)

(72) Inventors: Manabu ONO, Yokohama (JP); Takashi NAKAZAWA, Yokohama (JP); Sachiyo YAMADA, Yokohama (JP)

(21) Appl. No.: 17/255,728

(22) PCT Filed: Jul. 12, 2019
(86) PCT No.: PCT/US2019/041577

§ 371 Date: Dec. 23, 2020

(30) Foreign Application Priority Data
Aug. 7, 2018 (JP) 2018-148526

(51) Int. Cl. G03G 15/02; G03G 21/20; G03G 15/00

(52) U.S. Cl. CPC G03G 15/0266; G03G 15/5029; G03G 21/206

(57) ABSTRACT

An imaging system includes: a housing; an ionizer including a first electrode and a second electrode and to charge airborne particles contained in the housing; a particle filter collecting charged particles; and a controller changing an amount of a current flowing between the first electrode and the second electrode by electric discharge during a printing operation, in which the controller controls the amount of current based on a print state indicator associated with the printing operation.

### BACKGROUND

An image forming apparatus includes, for example, a conveying device which conveys a sheet, an image carrier on which an electrostatic latent image is formed, a developing device which develops the electrostatic latent image, a transfer device which transfers a toner image onto a sheet, a fixing device which fixes the toner image onto the sheet, and a discharge device which discharges the sheet.

### BRIEF DESCRIPTION OF DRAWINGS

FIG. 1 is a schematic diagram of an example image forming apparatus.

FIG. 2 is a schematic perspective view of an example trapping device.

FIG. 3 is a schematic side view of an example medium sensor.

FIG. 4 is a diagram showing graphs relating to an example current control.

FIG. 5 is a graph showing a relationship between a UFP emission amount and time of a reference example.

FIG. 6 is a table showing a relationship between a current amount and a UFP emission amount of the reference example.

FIG. 7 is a graph showing a relationship between a UFP emission amount and time in an example imaging system, and in comparison with the reference example.

FIG. 8 is a table showing a relationship between a current amount and a UFP emission amount of the an example imaging system and of the reference example.

FIG. 9 is a table relating to an example current control.

### DETAILED DESCRIPTION

Hereinafter, an example imaging system will be described with reference to the drawings. The imaging system is, for example, an image forming apparatus such as a printer, but may be a component which constitutes the image forming apparatus. For example, the imaging system may be a developing device used in the image forming apparatus or the like. In the following description, with reference to the drawings, the same reference numbers are assigned to the same components or to similar components having the same function, and overlapping description is omitted.

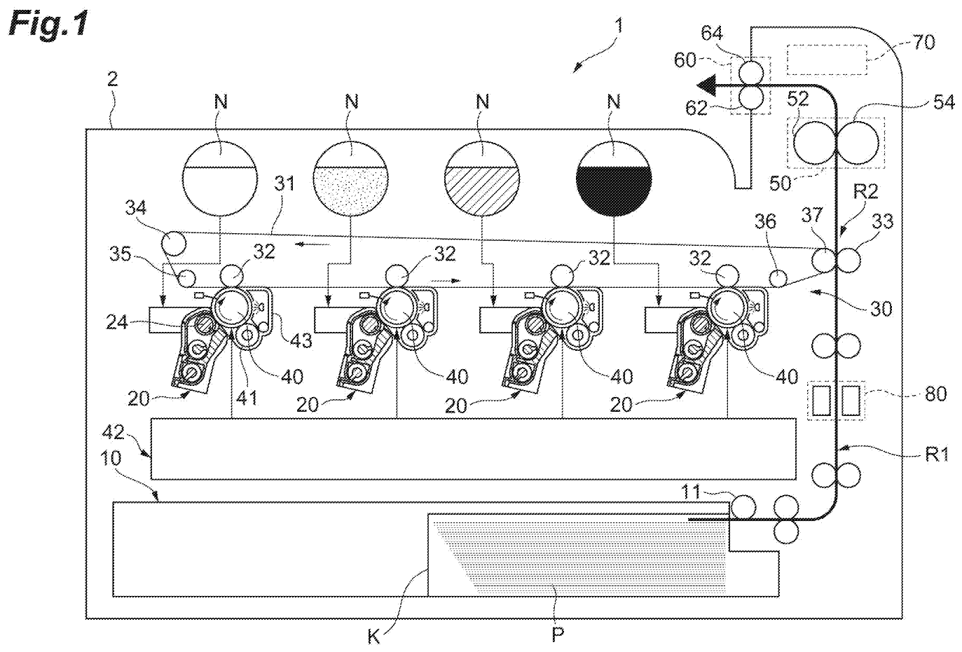

An image forming apparatus 1 illustrated in FIG. 1 may be an apparatus which forms a color image by using magenta, yellow, cyan, and black colors. The image forming apparatus 1 may include a housing 2, a conveying device 10 which conveys a sheet P corresponding to a print medium (or printing medium), a developing device 20 which develops an electrostatic latent image, a transfer device 30 which secondarily transfers a toner image onto the sheet P, an image carrier 40 on which the electrostatic latent image is formed, a fixing device 50 which fixes the toner image onto the sheet P, and a discharge device 60 which discharges the sheet P. The housing 2 may accommodate the conveying device 10, the developing device 20, the transfer device 30, the image carrier 40, the fixing device 50, and the discharge device 60.

The conveying device 10 may convey the sheet P as a print medium having an image formed thereon on a conveying route R1. The sheet P may be accommodated in a cassette K in a stacked state and is picked up and conveyed by the feeding roller 11. The conveying device 10 may allow the sheet P to reach a transfer nip portion R2 through the conveying route R1, for example, at a timing in which the toner image transferred to the sheet P reaches the transfer nip portion R2.

Four developing devices 20 may be provided for respective colors. Each developing device 20 may include a developing agent carrier 24 which carries toner on the image carrier 40. In the developing device 20 a two-component developing agent including toner and carrier may be used as the developing agent. In the developing device 20, the toner and the carrier may be adjusted and mixed to have a desired mixing ratio so that the toner is uniformly dispersed. Accordingly, the developing agent having an optimal charge amount may be adjusted. The developing agent may be carried on the developing agent carrier 24. The developing agent carrier 24 may rotate to convey the developing agent to a region facing the image carrier 40. Then, the toner in the developing agent carried on the developing agent carrier 24 may transfer to the peripheral surface of the image carrier 40 to form the electrostatic latent image on the image carrier 40, so that the electrostatic latent image is developed.

The transfer device 30 may convey the toner image formed by the developing device 20 to the transfer nip portion R2. The transfer device 30 may include a transfer belt 31 onto which the toner image is primarily transferred from the image carrier 40, suspension rollers 34, 35, 36, and 37 which suspend the transfer belt 31, a primary transfer roller 32 which sandwiches the transfer belt 31 along with the image carrier 40, and a secondary transfer roller 33 which sandwiches the transfer belt 31 along with the suspension roller 37.

The transfer belt 31 may be an endless belt which moves in a circulating manner by the suspension rollers 34, 35, 36, and 37. The suspension rollers 34, 35, 36, and 37 may be rollers which is rotatable about respective axes. The suspension roller 37 may be a drive roller which is rotationally driven to rotate about its axis. The suspension rollers 34, 35, and 36 may be driven rollers which rotate in a following manner in accordance with the rotational driving of the suspension roller 37. The primary transfer roller 32 may be provided to press the image carrier 40 from the inner peripheral side of the transfer belt 31. The secondary transfer roller 33 may be disposed in parallel to the suspension roller 37 with the transfer belt 31 interposed therebetween and may be provided to press the suspension roller 37 from the outer peripheral side of the transfer belt 31. Accordingly, the secondary transfer roller 33 may form the transfer nip portion R2 between the secondary transfer roller and the transfer belt 31.

The image carrier 40 may also be referred to as an electrostatic latent image carrier, a photosensitive drum, or the like. Four image carriers 40 may be provided for respective colors. Each image carrier 40 may be located along the trajectory (in the movement direction) of the transfer belt 31. For example, the developing device 20, a charging roller 41, an exposure unit 42, and a cleaning device 43 may be provided around the image carrier 40.

The charging roller 41 may be adapted to uniformly charge the surface of the image carrier 40 to a predetermined potential. The charging roller 41 may rotate to follow the rotation of the image carrier 40. The exposure unit 42 may expose the surface of the image carrier 40 charged by the charging roller 41 in response to an image formed on the sheet P. Accordingly, a potential of a portion exposed by the exposure unit 42 in the surface of the image carrier 40 may change so that the electrostatic latent image is formed. Four developing devices 20 may generate the toner image by developing the electrostatic latent image using the toner supplied from a toner tank N provided to face each developing device 20. Each toner tank N may be charged with each of magenta, yellow, cyan, and black toners. The cleaning device 43 may collect the toner remaining on the image carrier 40 after the toner image formed on the image carrier 40 is primarily transferred to the transfer belt 31.

The fixing device 50 may melt and fix the toner image, secondarily transferred from the transfer belt 31 to the sheet P, to the sheet P by allowing the sheet P to pass through a fixing nip portion in a heated and pressed state. The fixing device 50 may include a heating roller 52 which heats the sheet P and a pressing roller 54 which rotationally drives the heating roller 52 in a pressed state. Each of the heating roller 52 and the pressing roller 54 may be formed in a cylindrical shape and the heating roller 52 may include therein a heat source such as a halogen lamp. The fixing nip portion corresponding to a contact region may be provided between the heating roller 52 and the pressing roller 54, to melt and fix the toner image to the sheet P when the sheet P passes through the fixing nip portion.

The discharge device 60 may include discharge rollers 62 and 64 to discharge the sheet P onto which the toner image is fixed by the fixing device 50 to the outside of the apparatus.

Subsequently, an example of a printing process using the example image forming apparatus 1 will be described. When an image signal of a recording target image is input to the image forming apparatus 1, a control unit (not illustrated) of the image forming apparatus 1 picks up and conveys the sheet P stacked on the cassette K by rotating the feeding roller 11. Then, the surface of the image carrier 40 is uniformly charged to a predetermined potential by the charging roller 41 based on the received image signal (charging process). Subsequently, a laser beam is irradiated to the surface of the image carrier 40 by the exposure unit 42 so that the electrostatic latent image is formed (exposing process).

In the developing device 20, the electrostatic latent image is developed so that the toner image is formed (developing process). The toner image which is formed in this way is primarily transferred from the image carrier 40 to the transfer belt 31 in a region in which the image carrier 40 faces the transfer belt 31 (transfer process). The toner images formed on the four image carriers 40 are sequentially laminated on the transfer belt 31 so that one laminated toner image is formed. Then, the laminated toner image is secondarily transferred to the sheet P conveyed from the conveying device 10 in the transfer nip portion R2 in which the suspension roller 37 faces the secondary transfer roller 33.

The sheet P onto which the laminated toner image is secondarily transferred is conveyed to the fixing device 50. Then, the fixing device 50 melts and fixes the laminated toner image to the sheet P by heating and pressing the sheet P between the heating roller 52 and the pressing roller 54 at the time of allowing the sheet P to pass through the fixing nip portion (fixing process). Subsequently, the sheet P is discharged to the outside of the image forming apparatus 1 by the discharge rollers 62 and 64.

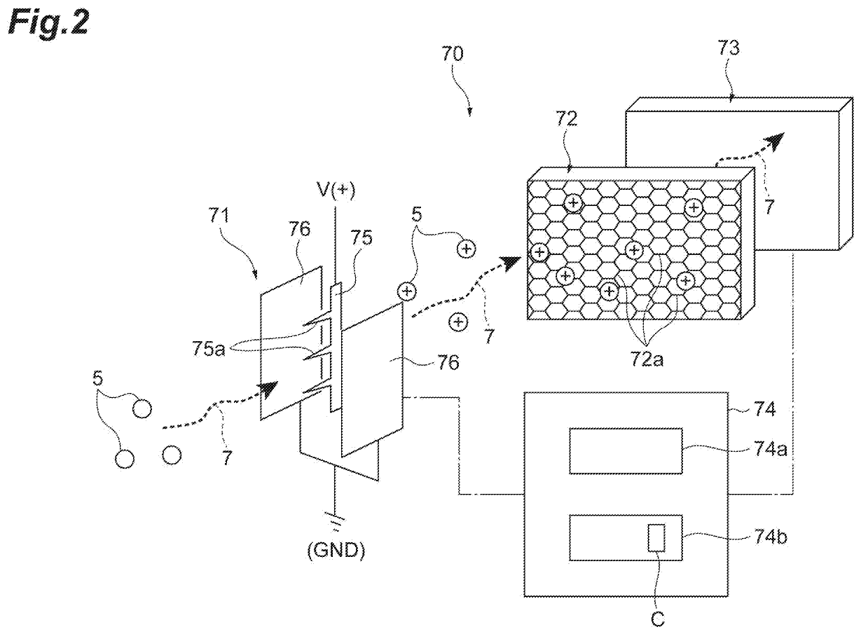

As illustrated in FIGS. 1 and 2, the example image forming apparatus 1 further includes a trapping device 70. The trapping device 70 may be located in the vicinity of the fixing device 50 inside the housing 2, to trap particles (airborne particles) 5 floating inside the housing 2. In some examples, the particles 5 have a size of about 50 nm to 300 nm. The particles may also be referred to as ultrafine particles (UFP) or airborne particles. When the trapping device 70 is disposed in the vicinity of the fixing device 50 in which the amount of UFP generation is relatively large, the trapping of the UFP can be improved.

The trapping device 70 may be provided by an electrostatic precipitator including an ionizer 71, a particle filter 72, an exhaust fan 73, and a controller 74. The ionizer 71 may include a first electrode (a discharge electrode) 75 and a pair of second electrodes (counter electrodes) 76. A high voltage is applied from a high-voltage power source (not illustrated) to the first electrode 75. The first electrode 75 may include a plurality of protrusions 75a for electric discharge. The plurality of protrusions 75a may be arranged at the same intervals. For example, the protrusions 75a may be equally spaced apart. Each protrusion 75a may be formed in a saw blade shape or a needle shape. The pair of second electrodes 76 may be grounded and disposed to face each other. The first electrode 75 may be disposed between the pair of second electrodes 76. FIG. 2 shows an example configuration of the ionizer 71, and however the ionizer may vary in configuration depending on examples. For example, the ionizer 71 may include a plurality of the first electrodes 75, and a plurality of the second electrodes 76 arranged alternately with the plurality of first electrodes 75.

In the example ionizer 71, when a voltage applied to the first electrode 75 is less than a predetermined value, no current flows between the first electrode 75 and the second electrode 76. However, when a voltage applied to the first electrode 75 is equal to or greater than a predetermined value, an electric discharge phenomenon occurs such that a current flows between the first electrode 75 and the second electrode 76. The ionizer 71 charges the particles 5 passing between the first electrode 75 and the second electrode 76 by the flowing current. As the voltage applied to the first electrode 75 increases, the amount (energization amount) of the current flowing between the first electrode 75 and the second electrode 76 increases.

The magnitude (or amount) of the voltage applied to the first electrode 75 is controlled by the controller 74. The controller 74 may perform a current control by controlling the high-voltage power source. That is, the controller 74 controls the magnitude of the voltage applied to the first electrode 75 to achieve a target value for the amount of the current flowing between the first electrode 75 and the second electrode 76. For example, the controller 74 may control the magnitude of the voltage applied to the first electrode 75 by varying, for example, a duty ratio of a PWM signal input to the high-voltage power source.

The leading end portion of the first electrode 75 may deteriorate with use. When the leading end portion deteriorates, the amount of the current flowing between the first electrode 75 and the second electrode 76 may change even when the voltage application amount is the same. In the example ionizer 71, the current amount can be stably adjusted to a target value even when the leading end portion deteriorates by performing the constant current control.

The particle filter 72 may include a lamination structure of polymer sheets subjected to an electret treatment, that include a plurality of tubular ventilation paths 72a. The surface of the particle filter 72 may be semi-permanently charged. Consequently, the particle filter 72 can collect the particles 5 charged by the ionizer 71. The electret treatment may be a treatment of solidifying a polymer material heated and melted while applying a high voltage thereto so as to have a structure for maintaining charging on the polymer material. For example, as illustrated in FIG. 2, the particle filter 72 may have a honeycomb structure or a corrugated structure.

The exhaust fan 73 may be an airflow generator which generates an airflow 7 for carrying the particles 5. The exhaust fan 73 may be disposed on the opposite side to the ionizer 71 with respect to, for example, the particle filter 72, to generate the airflow 7 so that the particles 5 charged by the ionizer 71 are carried to the particle filter 72.

The controller 74 may be electrically connected to the trapping device 70 and control the operation of the trapping device 70. The controller 74 may control the magnitude of the voltage applied to the first electrode 75 and control the operation of the exhaust fan 73. The controller 74 may be configured as a computer including a processor 74a such as a central processing unit (CPU) and a storage unit 74b such as a read only memory (ROM) and a random access memory (RAM). The storage unit 74b may also be referred to herein as storage or non-transitory storage device.

The storage unit 74b may store a current control program C. The storage unit 74b may be a non-transitory computer readable storage device (a storage medium) which stores the current control program C. The controller 74 is adapted to carry out a current control as described further below, by reading the current control program C to the processor 74a and executing the program.

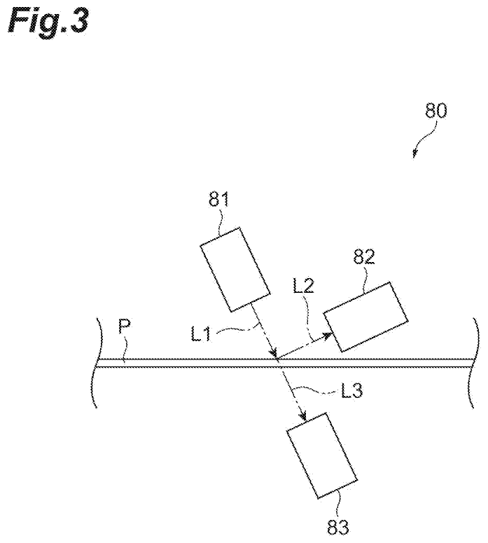

As illustrated in FIGS. 1 and 3, the example image forming apparatus 1 may further include a medium sensor 80 to detect, for example, a medium property of the sheet P stacked on the conveying route R1. The medium property (or properties) detected by the medium sensor 80 may include at least one of the water content and the thickness (for example, the basis weight) of the sheet P.

The medium sensor 80 may include a light emitting portion 81, a first light receiving portion 82, and a second light receiving portion 83. The light emitting portion 81 may include a light emitting element which irradiates light L1 to the sheet P conveyed by the conveying device 10. The first light receiving portion 82 may include a light receiving element which detects light L2 reflected by the sheet P. The second light receiving portion 83 may be a light receiving element which detects light L3 transmitted through the sheet P. In the medium sensor 80, at least one of the water content and the thickness of the sheet P can be detected based on the intensity of the light L3 detected by the second light receiving portion 83 and the intensity of the light L2 detected by the first light receiving portion 82. It is possible to calculate the water content of the sheet P by multiplying the water content by the basis weight.

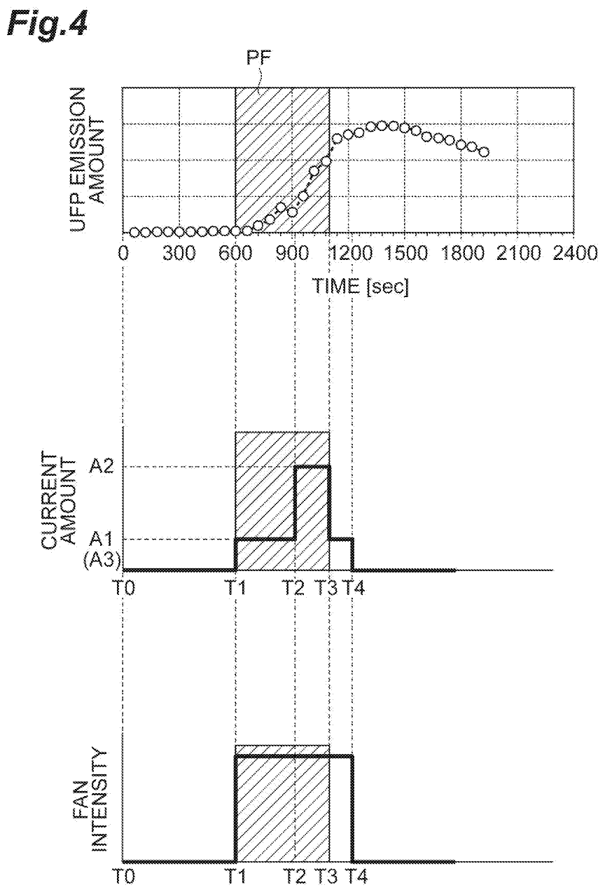

Referring to FIG. 4, an example current control performed by the example controller 74 in the image forming apparatus 1, will be described. In the example of FIG. 4, a printing operation of 500 pages is continuously performed. During a period from the time T0 to the time T1, the printing operation is not performed and no current flows between the first electrode 75 and the second electrode 76. A period from the time T1 to the time T3 represents a printing period PF of the printing operation. That is, the time T1 is a printing start time (start time of the printing operation) and the time T3 is a printing end time (end time of the printing operation). In this example, the time T1 is 600 seconds (10 minutes) after the time T0 and the time T3 is 1110 seconds (18 minutes and 30 seconds) after the time T0. In FIG. 4, the printing period PF is indicated by hatching.

The controller 74 controls the amount of the current flowing between the first electrode 75 and the second electrode 76 to a first amount A1 during a period from the time T1 to the time T2. The time T2 is, for example, 900 seconds (15 minutes) after the time T0. The first amount A1 is greater than zero. For example, first amount A1 may be 30 μA.

The controller 74 controls the amount of the current flowing between the first electrode 75 and the second electrode 76 to a second amount A2 during a period from the time T2 to the time T3. That is, the controller 74 increases the current amount from the first amount A1 to the second amount A2 during the printing operation. The controller 74 maintains the current amount to the second amount A2 until the printing operation ends. The second amount A2 is greater than the first amount A1. For example, the second amount A2 may be 90 μA.

The controller 74 controls the amount of the current flowing between the first electrode 75 and the second electrode 76 to a third amount A3 during a period from the time T3 to the time T4. That is, the controller 74 controls the current amount to the third amount A3 for a predetermined time (for example, 30 seconds) after the printing operation ends. This follows from the emission of UFP even during the period after the printing operation ends. The time T4 is, for example, 1170 seconds (19 minutes) after the time T0. The third amount A3 is less than the second amount A2. In this example, the third amount A3 is the same as the first amount A1, but may be greater than the first amount A1. The controller 74 controls the current amount to zero during a period after the time T4.

The controller 74 may operate the exhaust fan 73 during a period from the time T1 to the time T4. That is, the controller 74 operates the exhaust fan 73 throughout a period in which the amount of the current flowing between the first electrode 75 and the second electrode 76 is the first amount A1, the second amount A2, and the third amount A3. In this example, the controller 74 operates the exhaust fan 73 at the same intensity during a whole period from the time T1 to the time T4. For example, the controller 74 maintains a duty ratio of a PWM signal input to the exhaust fan 73 to 100% during a whole period from the time T1 to the time T4.

As described above, in this example current control, the controller 74 controls the amount of the current flowing between the first electrode 75 and the second electrode 76 during the printing operation based on a time elapsed (or an elapsed time) during the printing operation corresponding to the print state indicator associated with the printing operation. In this case, the print state indicator indicates the degree of progress (or progress degree) of the printing operation.

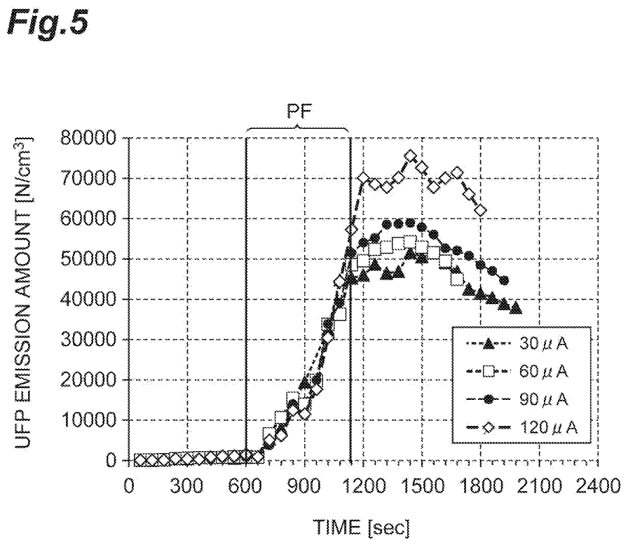

FIG. 5 is a graph showing a UFP emission amounts in relation to time, in a reference example.

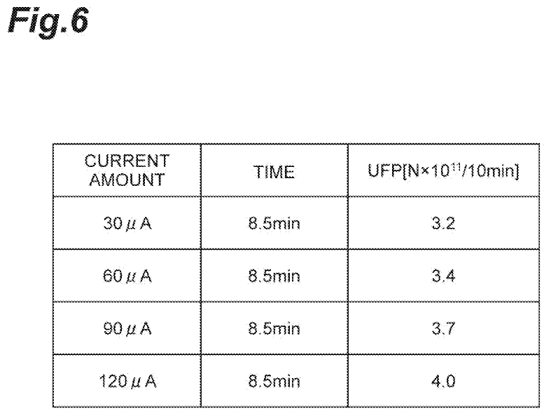

FIG. 6 is a table showing a relationship between a current amount and a UFP emission amount of the reference example. In the reference example, the current amount is controlled to 30 μA, 60 μA, 90 μA, or 120 μA during the printing period PF. Generally, it is considered that the UFP trapping efficiency of the trapping device 70 increases as the current amount increases. In contrast, as shown in FIGS. 5 and 6, in the reference example, as the current amount increases, the UFP emission amount increases and the UFP trapping efficiency of the trapping device 70 decreases.

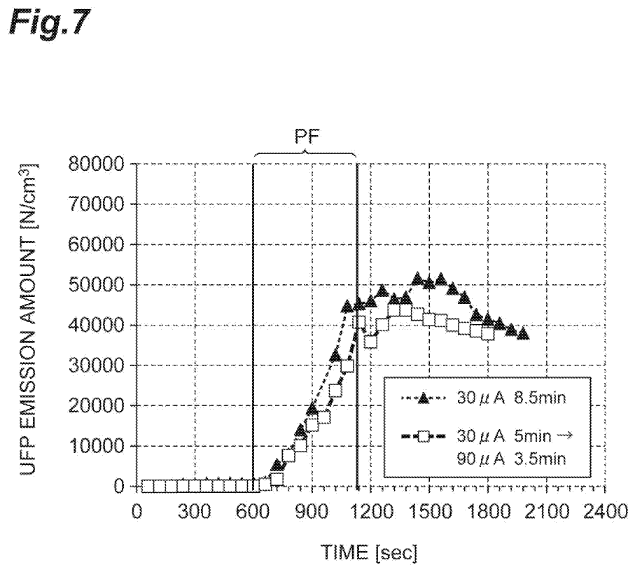

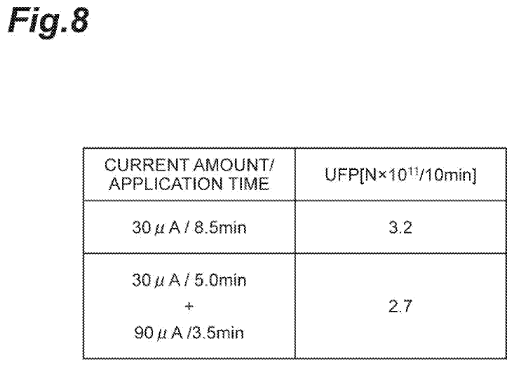

FIG. 7 is a graph showing the UFP emission amount in relation to time, in the reference example and in an example image forming apparatus 1. FIG. 8 is a table showing a relationship between the current amount and the UFP emission amount of the reference example and in the example image forming apparatus 1. FIGS. 7 and 8 show an example in which the current amount during a period from the time T1 to the time T2 is controlled to the first amount A1 and the current amount during a period from the time T2 to the time T3 is controlled to the second amount A2 as an example.

As shown in FIGS. 7 and 8, in the example image forming apparatus 1, the UFP emission amount decreases and the UFP trapping efficiency of the trapping device 70 is high as compared with the reference example. In this way, according to the above-described example current control, it is possible to improve the UFP trapping efficiency of the trapping device 70 and to decrease the UFP emission amount. This follows from the suppression of the excessive charging of the particles 5 in the particle filter 72 when the current amount at the initial printing stage having a small UFP emission amount is set to be relatively small. Further, according to the above-described example current control, it is possible to suppress deterioration of the first electrode 75 and to reduce a maintenance load.

It is to be understood that not all aspects, advantages and features described herein may necessarily be achieved by, or included in, any one particular example. Indeed, having described and illustrated various examples herein, it should be apparent that other examples may be modified in arrangement and detail.

For example, in the above-described current control, the number of sheets to be printed, the printing period PF, the time T1, the time T2, the time T3, the time T4, the first amount A1, the second amount A2, and the third amount A3 are merely examples and can be appropriately set and modified in response to a printing condition or the like. In the above-described examples, the controller 74 controls the current amount based on the time elapsed during the printing operation, but in some examples, the controller 74 may control the current amount based on the consumed toner amount during the printing operation. For example, the controller 74 may increase the current amount from the first amount A1 to the second amount A2 when the toner consumption amount exceeds a first threshold value. The controller 74 may decrease the current amount from the second amount A2 to the third amount A3 when the toner consumption amount exceeds a second threshold value greater than the first threshold value. That is, the controller 74 may determine the degree of progress (or progress degree) of the printing operation based on the elapsed time or may determine the progress degree of the printing operation based on the toner consumption amount. The toner consumption amount may be calculated based on, for example, the detection result of the sensor detecting the remaining toner amount or the printing condition or the like.

The controller 74 may control the intensity (e.g. an amount of airflow generation) of the exhaust fan 73 based on the progress degree of the printing operation. For example, the controller 74 may increase the current amount from the first amount A1 to the second amount A2 and increase the intensity of the exhaust fan 73 from a first intensity to a second intensity. The controller 74 may decrease the current amount from the second amount A2 to the third amount A3 and decrease the intensity of the exhaust fan 73 from the second intensity to the third intensity.

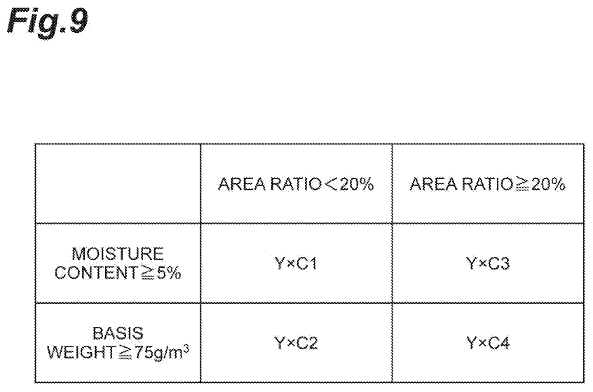

Referring to FIG. 9, another example current control will be described. In the current control, the controller 74 changes the amount of the current flowing between the first electrode 75 and the second electrode 76 during the printing operation based on the detection result of the medium sensor 80 and the area of the image printed on the sheet P (for example, the area ratio of the image of the sheet P which may be defined by the area of the printed image relative to the total area of the sheet P). For example, the medium property and the area ratio of the image of the sheet P are used as the print state indicator.

The controller 74 changes the current amount in response to a comparison (or comparison result) of the area ratio of the sheet P and the first threshold value. For example, the controller 74 may control the current amount when the area ratio is equal to or greater than the first threshold value to a large amount as compared with a case in which the area ratio is less than the first threshold value. This follows from the increase of the toner consumption amount and of the UFP emission amount when the area ratio increases. The first threshold value may be 20%, for example. The area ratio can be calculated, for example, based on the image signal of the recording target image input to the image forming apparatus 1.

The controller 74 may vary the current amount in response to a comparison (or comparison result) of the water content of the sheet P to a second threshold value. For example, the controller 74 controls the current amount when the water content is equal to or greater than the second threshold value to a large amount as compared with the current amount when the water content is less than the second threshold value. This follows from the increase of the amount of vapor generated in the fixing device 50 and of the UFP emission amount when the water content increases. The second threshold value is, for example, 5%. The controller 74 changes the current amount in response to a comparison (or comparison result) of the basis weight of the sheet P and a third threshold value. For example, the controller 74 controls the current amount when the basis weight is equal to or greater than the third threshold value to a large amount as compared with the current amount when the basis weight is less than the third threshold value. This follows from the increase of the heating amount of the fixing device 50 and of the UFP emission amount when the basis weight (thickness) increases. The third threshold value may be 75 g/m², for example. The water content and the basis weight are calculated based on the detection result of the medium sensor 80, but may be calculated based on the information input to the image forming apparatus 1.

For example, as shown in FIG. 9, the controller 74 may set (or control) the current amount to a value obtained by multiplying a reference value Y by a first coefficient C1 when the area ratio of the image of the sheet P is less than the first threshold value and the water content is equal to or greater than the second threshold value. The controller 74 may set (or control) the current amount to a value obtained by multiplying the reference value Y by a second coefficient C2 when the area ratio is less than the first threshold value and the basis weight is equal to or greater than the third threshold value. The controller 74 may set (or control) the current amount to a value obtained by multiplying the reference value Y by a third coefficient C3 when the area ratio is equal to or greater than the first threshold value and the water content is equal to or greater than the second threshold value. The controller 74 may set (or control) the current amount to a value obtained by multiplying the reference value Y by a fourth coefficient C4 when the area ratio is equal to or greater than the first threshold value and the basis weight is equal to or greater than the second threshold value. The first coefficient C1 and the second coefficient C2 may be, for example, values in the range of 1.2 to 1.5. In some examples, the third coefficient C3 and the fourth coefficient C4 may be values greater than 1.5. In some examples, the third coefficient C3 and the fourth coefficient C4 may be equal (the same value). The controller 74 may set (or control) the current amount to the reference value Y when the area ratio is less than the first threshold value, the water content is less than the second threshold value, and the basis weight is less than the third threshold value. Also by such a current control, it is possible to improve the UFP trapping efficiency of the trapping device 70 and to decrease the UFP emission amount.

1. An imaging system comprising:
a housing;
an ionizer including a first electrode and a second electrode and to charge airborne particles contained in the housing;
a particle filter to collect charged particles; and
a controller to vary an amount of a current which flows between the first electrode and the second electrode by electric discharge during a printing operation, the controller to control the amount of current based on a print state indicator associated with the printing operation.

2. The imaging system according to claim 1, wherein the print state indicator indicates a degree of progress of the printing operation,
the controller to increase the amount of current during the printing operation, from a first amount which is greater than zero to a second amount greater than the first amount.

3. The imaging system according to claim 2, the controller to determine the degree of progress based on a toner amount consumed during the printing operation.

4. The imaging system according to claim 2, the controller to determine the degree of progress based on a time elapsed during the printing operation.

5. The imaging system according to claim 2, the controller to maintain the current amount at the second amount until a conclusion of the printing operation.

6. The imaging system according to claim 5, the controller to set the current amount to a third amount greater than the first amount during a predetermined period of time following the conclusion of the printing operation.

7. The imaging system according to claim 6, wherein the third amount is less than the second amount.

8. The imaging system according to claim 6, further comprising:
an airflow generator to generate an airflow to carry the airborne particles,
the controller to operate the airflow generator throughout a period at which the current amount is set to the first amount, the second amount, and the third amount.

9. The imaging system according to claim 1, further comprising:
an airflow generator to generate an airflow according to an airflow generation amount, to carry the airborne particles,
the controller to control the airflow generation amount of the airflow generator based on the print state indicator.

10. The imaging system according to claim 1,
wherein the print state indicator indicates a medium property associated with a print medium used in the printing operation,
the controller to vary the current amount in response to a comparison of the medium property to a threshold value, during the printing operation.

11. The imaging system according to claim 10, the controller to determine the medium property based on a water content of the print medium.

12. The imaging system according to claim 10, the controller to determine the medium property based on a thickness of the print medium.

13. The imaging system according to claim 10, further comprising:
a medium sensor to detect the medium property, wherein the medium sensor includes a light emitting portion to irradiate light to the print medium and a light receiving portion to detect the light reflected from the print medium.

14. The imaging system according to claim 1, wherein the print state indicator indicates an area of an image printed on a print medium during the printing operation,
the controller to vary the current amount during the printing operation, in response to a comparison of the area and a threshold value.

15. A non-transitory storage device having instructions stored thereon that, in response to execution by a controller for an imaging system including an ionizer, cause the controller to perform operations comprising:
comparing a print state indicator associated with the printing operation to a threshold value; and
varying an amount of a current flowing between a first electrode and a second electrode of the ionizer by electric discharge during a printing operation, based on the comparison of the print state indicator.
